(19) United States
(12) Patent Application Publication
(10) Pub. No.: US 2020/0410422 A1
(43) Pub. Date: Dec. 31, 2020

(54) LABORATORY INSTRUMENT SELECTION AND CONFIGURATION

(71) Applicant: Beckman Coulter, Inc., Brea, CA (US)

(72) Inventors: Sohrab FARAMARZI OGHANI, Villeneuve d'Ascq (FR); Eric VARLET, Arras (FR); Martin BUE, Villeneuve d'Ascq (FR); Pr. El Ghazali TALBI, Villeneuve d'Ascq (FR)

(21) Appl. No.: 16/954,240

(22) PCT Filed: Dec. 17, 2018
(86) PCT No.: PCT/US2018/065996

§ 371 Date: Jun. 16, 2020

Related U.S. Application Data
(60) Provisional application No. 62/607,624, filed on Dec. 19, 2017.

(51) Int. Cl. G06Q 10/06; G01N 35/00; G06Q 30/06

(52) U.S. Cl. CPC G06Q 10/06315; G01N 2035/0094; G06Q 30/0631; G01N 35/0092

(57) ABSTRACT

Laboratory instrument selection and the allocation of reagents to laboratory instruments may be optimized by using computer programs which minimize cost functions relative to various types of constraints. These constraints may include demand for tests, laboratory instrument operational capacity, laboratory instrument reagent capacity, and so on. In some embodiments, this optimization may combine reagent allocation with machine selection to aid in the selection of appropriate laboratory instruments.

### TECHNICAL FIELD

The technology disclosed herein may be applicable to the selection and/or configuration of various types of lab instruments.

### BACKGROUND

Generally, laboratories such as may perform tests on various types of substances may require both laboratory instruments to perform the tests and reagents with which the tests may be performed. Various ways of balancing competing considerations related to laboratory instrument selection and reagent allocation have been tried. However, it is believed that no approach to selecting laboratory instruments and configuring them with reagents or other consumables as described herein has previously been used in the art.

### SUMMARY

The disclosed technology can be used to implement a variety of methods, systems, machines and computer program products. For example, in some aspects, based on this disclosure one of ordinary skill in the art may implement a method comprising defining a formal representation of demand for tests to be performed at a laboratory and providing a recommendation of one or more laboratory instruments to use in performing the tests and an allocation of reagents among the one or more laboratory instruments based on the formal representation comprising a set of pre-defined parameters to optimize a cost associated with performing the test. Computer program products comprising instructions operable to configure a computer to perform such methods, and machines comprising computers configured with instructions operable to, when executed, cause the computer to perform such methods, may also be implemented in some aspects.

Further information on how the disclosed technology could potentially be implemented is set forth herein, and variations on the sample will be immediately apparent to and could be practiced without undue experimentation by those of ordinary skill in the art based on the material which is set forth in this document. Accordingly, exemplary methods and machines described in this summary should be understood as being illustrative only, and should not be treated as limiting on the scope of protection provided by this or any related document.

### BRIEF DESCRIPTION OF DRAWINGS

FIG. 1 is a block diagram of an environment in which aspects of the technology described herein may be deployed in some embodiments.

FIG. 2 illustrates a method which may be used in some embodiments to determine how analytic instruments in a laboratory could be stocked with reagents.

### DETAILED DESCRIPTION

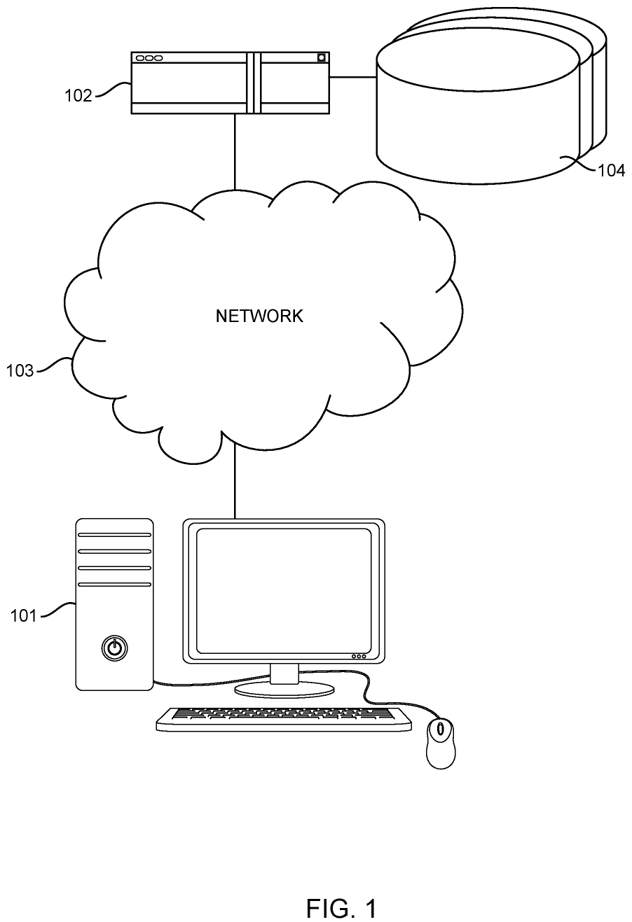

Turning now to the figures, FIG. 1 is a block diagram of an environment in which aspects of the technology described herein may be deployed in some embodiments. In that environment, in some embodiments a user computer 101 (e.g., at a laboratory) may connect to a server 102 over a network 103. The server 102, in response to a request from the user computer 101 may provide the user computer with an interface. For example, the server 102 could be a web server connected to the user computer 101 over the Internet which is configured to send HTML, JavaScript, and/or other code to be interpreted by a browser on the user computer 101 in response to a GET command In such an implementation, the code which would be sent to the user computer 101 may be stored on the server 102, or one or more databases 104, or could be dynamically generated by the server 102 in response to a request from the user computer 101. Once the code is received at the user computer 101, a user may then use the interface provided by that computer 101 to view the information provided by the server 102, and or engage in further interactions. For example, in some embodiments a user could provide information to the server 102 which the server would then process (e.g., through execution of instructions stored in its memory) to provide one or more results back to the user computer 101.

Some embodiments may use alternatives to a browser based interface such as described above. For example, in some embodiments a user computer 101 may be provided with a special purpose client application which may automatically interact with a server 102 using custom data transmission protocols, rather than relying on a browser which would interpret general purpose languages, such as HTML, JavaScript or others. Similarly, it is possible that, rather than using an architecture with a remote server as shown in FIG. 1, in some implementations functionality such as described for the architecture of FIG. 1 may be provided locally on the user computer 101 itself. Accordingly, the discussion above of architectures in which processing is performed primarily on a server 102 remote from a user computer 101 should be understood as being illustrative only, and should not be treated as limiting on the protection provided by this document or any other document claiming the benefit of this disclosure.

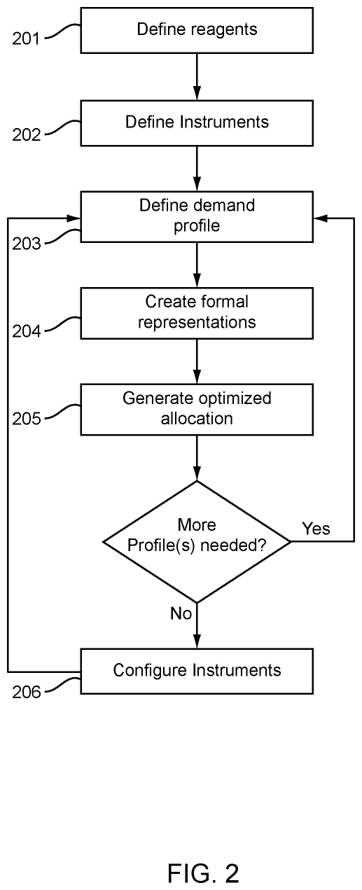

Turning now to FIG. 2, that figure illustrates a method which may be used in some embodiments to determine how analytic instruments in a laboratory could be stocked with reagents. As shown in FIG. 2, such a method may, in some embodiments, include a step of defining 201 the reagents which could be allocated among the laboratory instruments. This may include, for example, specifying the reagents' attributes, such as the size(s) of container(s) they come in (e.g., small medium and large bottles), the number of positions in an analytic instrument the various containers may occupy, the number of tests which may be performed with the reagents in a particular size of container using a particular type of laboratory instrument, and the costs of various containers of reagents. Similarly, a method such as shown in FIG. 2 may also include a step of defining 202 the laboratory instruments the reagents could be allocated to. This may include, for example, specifying what laboratory instruments would be configured (e.g., what analyzers are present in the laboratory that would have reagents allocated to them), as well as various attributes of those laboratory instruments, such as what tests they could potentially perform, the cost for calibrating them for particular tests, and their capacity for holding reagents. The method of FIG. 2 also includes defining 203 a demand profile for the laboratory, which could include defining the demand for various types of tests at the laboratory as equal to the average numbers of each of those types of tests which the laboratory performs (or would be expected to perform) in a given day (or other period of time between reagent refills).

In the process of FIG. 2, with demand, laboratory instruments and reagents defined 201 202 203, formal representations of the demand, laboratory instrument and reagent information would be created 204. This could be done, for example, by taking information obtained during the preceding definition steps 201 202 203 and using it as parameters for a set of equations which had been developed to allow for modeling of laboratory activities. For instance, in some embodiments equations 1-6 (below) may be used in creating 204 formal representations, and the parameters for those equations could be specified during the reagent, laboratory instrument and demand profile definition steps 201 202 203.

| | |
|---|---|
| Equation 1 | AOCⱼ ≤ τⱼgⱼ; ∀ j ∈ M^{A} |

An equation showing that Analyzer Operational Capacity for analyzer j (AOCⱼ) must
be modeled as less than or equal to the daily available working hours of analyzer j (τⱼ)
multiplied by the hourly capacity of analyzer j in terms of tests (gⱼ). In this equation
this must be true for every analyzer in the set of analyzers for the lab (M^{A}).

| | |
|---|---|
| Equation 2 | ${AOC}_{j} \leq {\sum }_{h ∈ H} {\sum }_{s ∈ Q} {δ}_{hsj} {x}_{hsj} ; ∀ j ∈ {M}^{A}$ |

An equation showing Analyzer Operational Capacity of analyzer j must be modeled as
less than or equal to the sum of products of (a) the number of reagents for test h with
bottle size s which are positioned in analyzer j (i.e., xₕₛⱼ) multiplied by (b) the average
number of times test h can be performed using one bottle of size s in analyzer j (i.e.,
δₕₛⱼ). In this equation this must also be true for every analyzer in the set of analyzers for
the lab (M^{A}).

| | |
|---|---|
| Equation 3 | ${\sum }_{j ∈ {M}^{A}} {MD}_{jd} {AOC}_{j} \geq {\sum }_{h ∈ H} {HD}_{hd} {F}_{h} ; ∀ d ∈ D$ |

An equation showing the total Analyzer Operational Capacity for all analyzers in a
particular discipline must be greater than or equal to the total number of tests (Fₕ) in
that discipline. In this equation this must be true for each discipline d in the set of
disciplines (D). In this equation, to ensure that irrelevant demand and capacity
information does not impact the evaluation, the parameters MD_{jd} and HD_{hd} are used,
with MD_{jd} being set to 1 if analyzer j belongs to discipline d and 0 otherwise, and HD_{hd}
being set to 1 if test h is in discipline d and 0 otherwise.

| | |
|---|---|
| Equation 4 | ${\sum }_{j ∈ {M}^{A}} {\sum }_{s ∈ Q} {δ}_{hsj} {x}_{hsj} \geq {F}_{h} ; ∀ h ∈ H$ |

An equation showing that the average number of times test h is requested to be
performed in a day (Fₕ) must be less than or equal to the sum for all analyzers and bottle
sizes of the products of (a) the number of reagents for test h with bottle size s which are
positioned in analyzer j (i.e., xₕₛⱼ) multiplied by (b) the average number of times test h
can be performed using one bottle of size s in analyzer j (i.e., δₕₛⱼ). In this equation, this
must be true for every test in the set of tests for the lab (H).

| | |
|---|---|
| Equation 5 | ${\sum }_{h ∈ H} {\sum }_{s ∈ Q} {λ}_{hs} {x}_{hsj} \leq {RK}_{j} ; ∀ j ∈ {M}^{A}$ |

An equation showing the sum of the number of positions occupied by the reagent bottle
for test h with size s (λₕₛ) multiplied by the number of such bottles positioned into
analyzer j (xₕₛⱼ) must be less than or equal to the number of available reagent bottle
positions in analyzer j (RKⱼ). In this equation, this must be true for every analyzer in the
set of analyzers for the lab (M^{A}).

| | |
|---|---|
| Equation 6 | ${\sum }_{s ∈ Q} {λ}_{hs} {x}_{hsj} \leq {RK}_{j} {y}_{hj} ; ∀ j ∈ {M}^{A} , h ∈ H$ |

An equation showing the sum of the number of positions occupied by the reagent bottle
for test h with size s (λₕₛ) multiplied by the number of such bottles positioned into
analyzer j (xₕₛⱼ) must be less than or equal to the number of available reagent bottle
positions in analyzer j (RKⱼ) multiplied by a factor indicating if test h is available on
analyzer j (yₕⱼ, which is 1 if test h is available on analyzer j and is 0 otherwise).

Continuing with the discussion of FIG. 2, in the process depicted in that figure, once the formal representations of the reagents, laboratory instruments and demand have been created 204 for the lab, those representations can be used with a linear solver (e.g., the Cplex solver from IBM) to minimize a function representing cost to the lab of various configurations. For example, in some embodiments, constraints such as set forth above in equations 1-6 could be combined with a cost function such as shown in equation 7 to create a set of equations which, when the cost function is minimized, could generate 205 an optimized allocation of reagents among a laboratory's instruments.

| | |
|---|---|
| Equation 7 | ${\sum }_{h ∈ H} {\sum }_{s ∈ Q} {\sum }_{j ∈ {M}^{A}} {RC}_{hsj} {x}_{hsj} + {\sum }_{h ∈ Q} {\sum }_{j ∈ {M}^{A}} {ϱ}_{hj} {y}_{hj}$ |

An exemplary cost function, in which RCₕₛⱼ is the cost of a reagent bottle
with size s used for test h in analyzer j, [symbol] ₕⱼ is the calibration cost of test h
on analyzer j, and all other values have the same meanings as given above
in the context of equations 1-6.

Also, as shown in FIG. 2, in some embodiments, after an optimized allocation has been generated 205 the steps of defining 203 a demand profile, creating formal representations 204 and generating 205 an optimized allocation may be repeated. This may be useful, for example, in a case where a laboratory organizes its work so that certain types of tests are performed on certain days of the week, which may lead to better results being possible if different demand profiles are created for different days of the week.

Finally, after the appropriate allocation(s) has/have been generated 205, the reagents may be allocated 206 to the instrument(s) according to the generated allocations. For example, if a solver identifies a set of values for xₕₛⱼ (each of which would represent a number of reagent bottles of size s for test h that should be assigned to analyzer j) which would result in minimization of the cost function of equation 7, then for a period of time during which the demand profile used to derive that set of values was deemed valid (e.g., a month) the analytic instruments in the lab could be stocked with the numbers and sizes of reagent bottles provided by the generated set of xₕₛⱼ values. Then, when the demand profile(s) were no longer valid (e.g., at the end of a month), new profile(s) may be defined 203, new allocations may be generated 205, and the process may repeat.

It should be understood that, while the above discussion provided a set of equations which some embodiments may use in determining an optimized allocation of reagents to laboratory instruments, use of the above equations is not mandatory, and other embodiments may use other equations. For example, in some embodiments, a set of equations such as equations 1-7 above may be decomposed into separate sets of equations for each of the disciplines of the tests that a laboratory performs, and those separate sets of equations may be optimized individually to find allocations for each of the instruments in the lab. To illustrate, consider table 1, below, which presents a set of equations that could be used for determining optimized allocations for specific disciplines.

TABLE 1

| | |
|---|---|
| Minimize | |
| | ${\sum }_{h ∈ {H}^{d}} {\sum }_{s ∈ Q} {\sum }_{j ∈ X} {RC}_{hsj} {x}_{hsj} + {\sum }_{h ∈ {H}^{d}} {\sum }_{j ∈ X} {ϱ}_{hj} {y}_{hj}$ |
| Subject | AOCⱼ ≤ τⱼgⱼ; ∀ j ∈ X |
| to | |
| | ${AOC}_{j} \leq {\sum }_{h ∈ {H}^{d}} {\sum }_{s ∈ Q} {δ}_{hsj} {x}_{hsj} ; ∀ j ∈ X$ |
| | ${\sum }_{j ∈ X} {AOC}_{j} \geq {\sum }_{h ∈ {H}^{d}} {F}_{h}$ |
| | ${\sum }_{j ∈ X} {\sum }_{s ∈ Q} {δ}_{hsj} {x}_{hsj} \geq {F}_{h} ; ∀ h ∈ {H}^{d}$ |
| | ${\sum }_{h ∈ {H}^{d}} {\sum }_{s ∈ Q} {λ}_{hs} {x}_{hsj} \leq {RK}_{j} ; ∀ j ∈ X$ |
| | ${\sum }_{s ∈ Q} {λ}_{hs} {x}_{hsj} \leq {RK}_{j} {y}_{hj} ; ∀ j ∈ X , h ∈ {H}^{d}$ |
| | AOCⱼ ≥ 0 and integer, ∀ j ∈ X |
| | xₕₛⱼ ≥ 0 and integer, ∀ h ∈ H^{d}; s ∈ Q; j ∈ X |
| | yₕⱼ ∈ {0, 1}, ∀ h ∈ H^{d}; j ∈ X |

In the set of equations of table 1, X and H^{d} would represent, respectively, the laboratory instruments and tests which were specific to the particular discipline under consideration.

Other variations may also be possible in some embodiments. For example, some embodiments may apply techniques similar to those described above for determining an optimized allocation of reagents to the problem of determining an optimized selection of instruments for a lab. This may be done, for example, in a case where a new lab is being set up and a consultant or sales representative is making recommendations regarding the equipment which the lab may want to purchase. In this type of case, equations such as equations 8-14 below may be used to represent constraints to be considered in the instrument selection problem, while equation 15 may represent a cost function which would be minimized to determine an optimal selection of instruments.

| | |
|---|---|
| Equation 8 | ${\sum }_{j ∈ {M}^{IMM}} {τ}_{j} {g}_{j} {u}_{j} \geq {\sum }_{h ∈ {H}^{IMM}} {F}_{h}$ |

The sum of the daily available working hours for each instrument (τⱼ), in the set of
instruments in the immunology discipline (M^{IMM}) multiplied by the capacity of those
instruments in terms of tests (gⱼ), multiplied by the number of those instruments that
would be available (uⱼ) must be greater than the number of times test h is requested to
be performed in a day (Fₕ) for all tests in the immunology discipline (H^{IMM}).

| | |
|---|---|
| Equation 9 | ${\sum }_{j ∈ {M}^{CHEM}} {τ}_{j} {g}_{j} {u}_{j} \geq {\sum }_{h ∈ {H}^{CHEM}} {F}_{h}$ |

The sum of the daily available working hours for each instrument (τⱼ), in the set of
instruments in the chemistry discipline (M^{CHEM}) multiplied by the capacity of those
instruments in terms of tests (gⱼ), multiplied by the number of those instruments that
would be available (uⱼ) must be greater than the number of times test h is requested to
be performed in a day (Fₕ) for all tests in the chemistry discipline (H^{CHEM}).

| | |
|---|---|
| Equation 10 | ${\sum }_{j ∈ {M}^{HEM}} {τ}_{j} {g}_{j} {u}_{j} \geq {\sum }_{h ∈ {H}^{HEM}} {F}_{h}$ |

The sum of the daily available working hours for each instrument ( ), in the set of
instruments in the hematology discipline (M^{HEM}) multiplied by the capacity of those
instruments in terms of tests (gⱼ), multiplied by the number of those instruments that
would be available (uⱼ) must be greater than the number of times test h is requested to
be performed in a day (Fₕ) for all tests in the hematology discipline (H^{HEM}).

| | |
|---|---|
| Equation 11 | ${\sum }_{j ∈ {M}^{COAG}} {τ}_{j} {g}_{j} {u}_{j} \geq {\sum }_{h ∈ {H}^{COAG}} {F}_{h}$ |

The sum of the daily available working hours for each instrument (τⱼ), in the set of
instruments in the coagulation discipline (M^{COAG}) multiplied by the capacity of those
instruments in terms of tests (gⱼ), multiplied by the number of those instruments that
would be available (uⱼ) must be greater than the number of times test h is requested to
be performed in a day (Fₕ) for all tests in the coagulation discipline (H^{COAG}).

| | |
|---|---|
| Equation 12 | ${\sum }_{j ∈ {M}^{NA - C}} {τ}_{j} {ϕ}_{j} {u}_{j} \geq {\sum }_{d ∈ D} {DC}_{d} {θ}_{d} + ω$ |

The sum of the daily available working hours (τⱼ) for centrifugation machines (i.e.,
machines in the set M^{NA-C}) multiplied by the average number of tubes that can be
processed by those machines per hour (φⱼ), multiplied by the number of those machines
that would be available (uⱼ) must be greater than or equal to the average daily number
of tubes which require only centrifugation (ω) plus the sum total of the average daily
number of tubes requested in each discipline d (θ_{d}) multiplied by a parameter which is
1 if tubes in discipline d need to be centrifuged and is 0 otherwise (DC_{d}).

| | |
|---|---|
| Equation 13 | ${\sum }_{j ∈ {M}^{NA - AT}} {τ}_{j} {ϕ}_{j} {u}_{j} \geq η \cdot {\sum }_{d ∈ D} {θ}_{d} +$ |

The sum of the daily available working hours (τⱼ) for tube sorting and routing machines
(i.e., machines in the set M^{NA-AT}) multiplied by the average number of tubes that can be
processed by those machines per hour (φⱼ), multiplied by the number of those machines
that would be available (uⱼ) must be greater than or equal to the average daily number
of tubes which require only sorting ( [symbol] ) plus the product of the daily average number of
tubes required in each discipline (θ_{d}) multiplied by the average number of times that a
tube passes through a sorting and routing machine (η).

| | |
|---|---|
| Equation 14 | ${\sum }_{j ∈ M} {ψ}_{j} {u}_{j} \leq β$ |

The total space required for each individual instrument j (φⱼ) multiplied by a positive
integer representing the number of instruments of type j that would be available (uⱼ)
must be less than the total space available in the lab (β).

| | |
|---|---|
| Equation 15 | ${\sum }_{j ∈ M} ( {PC}_{j} + {SC}_{j} ) {u}_{j}$ |

A cost function reflecting the sum of the cost for each instrument j (PCⱼ) plus the average
cost to configure instrument j for normal use for the period equal to the lifespan of the
instrument (SCⱼ).

It is also possible that some embodiments may combine optimized instrument selection with optimized reagent allocation. Some embodiments may include a step of pre-calculating the number of each type of instrument to include in a set of potential analyzers, in order to ensure that enough potential instruments of each type are included while also providing bounds which could help reduce the risk that the optimization problem would be incomputable. In embodiments where this type of pre-calculation takes place, equations 16-19, below, may be used to define the number of potential instruments of each type.

| | |
|---|---|
| Equation 16 | $[ \frac{{V}_{d}}{{τ}_{α} {g}_{α}} ] + 1$ |

An equation which may be used to determine the number of analyzers of type α
belonging to discipline d should be included in the set of potential instruments. In
equation 16, τ_{α} is the daily available working hours of a instrument of type α, g_{α} is the
hourly capacity of an analyzer of type α in terms of tests and V_{d} is the total average
number of daily requested tests in discipline d.

| | |
|---|---|
| Equation 17 | (Σₕ₌₁^{o} HD_{hd}Fₕ) |

An equation which may, in some embodiments, be used to calculate the total average
number of daily requested tests in each discipline. In equation 17, Fₕ is the average
number of tests of type h requested through all daily requested tubes, and HD_{hd} is a
parameter which is set to 1 if test h is in discipline d and is 0 otherwise.

| | |
|---|---|
| Equation 18 | $[ \frac{{\sum }_{d = 1}^{p} {DC}_{d} {θ}_{d} + ω}{{τ}_{α} {ϕ}_{α}} ] + 1$ |

An equation which may, in some embodiments, be used to determine the number of
centrifugation machines of type α to include in the set of potential machines. In equation
18, DC_{d} is a parameter which is set to 1 if tubes in discipline d need centrifugation and
0 otherwise, θ_{d} is the average number of daily requested tubes in discipline d, ω is the
average number of daily requested tubes which only require centrifugation, τ_{α} is the
daily available working hours of a machine of type α and φ_{α} is the average hourly
capacity of centrifugation machine of type α in terms of tubes.

| | |
|---|---|
| Equation 19 | $[ \frac{η \cdot ( {\sum }_{d = 1}^{p} {θ}_{d} + )}{{τ}_{α} {ϕ}_{α}} ] + 1$ |

An equation which may, in some embodiments, be used to determine the number of
sorting and routing machines of type α to include in the set of potential machines. In
equation 19, η is the average number of times a tube passes through the sorting and
routing machine, θ_{d} is the average number of daily requested tubes in discipline d, [symbol] is
the average number of daily requested tubes which only require sorting, τ_{α} is the daily
available working hours of a machine of type α and φ_{α} is the average hourly capacity of
a sorting and routing machine of type α in terms of tubes.

In an embodiment which uses equations such as equations 16-19 to define the set of potential instruments (M), and which uses uⱼ as a decision variable which is 1 if instrument j from set M is selected and 0 otherwise, a set of equations such as shown in table 2 (below) could be used to define both the constraints which a laboratory would have to satisfy, as well as the cost function to be minimized by appropriate selection of instruments and allocation of reagents.

TABLE 2
Minimize

| | |
|---|---|
| | ${\sum }_{j ∈ M} \frac{1}{ND * {LS}_{j}} {PC}_{j} {u}_{j} + {\sum }_{h ∈ H} {\sum }_{s ∈ Q} {\sum }_{j ∈ {M}^{A}} {RC}_{hsj} {x}_{hsj} + {\sum }_{h ∈ Q} {\sum }_{j ∈ {M}^{A}} {ϱ}_{hj} {y}_{hj}$ |
| Subject | AOCⱼ ≤ τⱼgⱼuⱼ; ∀ j ∈ M^{A} |
| to | |
| | ${AOC}_{j} \leq {\sum }_{h ∈ H} {\sum }_{s ∈ Q} {δ}_{hsj} {x}_{hsj} ; ∀ j ∈ {M}^{A}$ |
| | ${\sum }_{j ∈ {M}^{A}} {MD}_{jd} {AOC}_{j} \geq {\sum }_{h ∈ H} {HD}_{hd} {F}_{h} ; ∀ d ∈ D$ |
| | ${\sum }_{j ∈ {M}^{A}} {\sum }_{s ∈ Q} {δ}_{hsj} {x}_{hsj} \geq {F}_{h} ; ∀ h ∈ H$ |
| | ${\sum }_{h ∈ H} {\sum }_{s ∈ Q} {λ}_{hs} {x}_{hsj} \leq {RK}_{j} {u}_{j} ; ∀ j ∈ {M}^{A}$ |
| | ${\sum }_{s ∈ Q} {λ}_{hs} {x}_{hsj} \leq {RK}_{j} {y}_{hj} ; ∀ j ∈ {M}^{A} , h ∈ H$ |
| | yₕⱼ ≤ HMₕⱼ; ∀ j ∈ M^{A}, h ∈ H |
| | ${\sum }_{j ∈ {M}^{NA - C}} {τ}_{j} {ϕ}_{j} {u}_{j} \geq {\sum }_{d ∈ D} {DC}_{d} {θ}_{d} + ω$ |
| | ${\sum }_{j ∈ {M}^{NA - AT}} {τ}_{j} {ϕ}_{j} {u}_{j} \geq η \cdot {\sum }_{d ∈ D} {θ}_{d} +$ |
| | ${\sum }_{j ∈ M} {ψ}_{j} {u}_{j} \leq β$ |

In the set of equations of table 2, uⱼ is 1 if instrument j is selected and is otherwise 0, HMₕⱼ is 1 if test h can potentially be done by analyzer j and is otherwise 0, LSⱼ denotes the lifespan of machine j, ND denotes the number of lab working days per year (e.g., ND=365) and the remaining parameters have the same meanings set forth in the context of equations 3-7 and 12-14 and table 1.

Of course, it should be understood that, in some embodiments, additional variations for organizing equations used to optimize instrument selection and/or configuration may be possible. For example, in some embodiments, the problem of selecting non-analytical instruments (e.g., centrifuges) may be separated out and addressed by minimizing equation 20, below, subject to the constraints of equations 12 and 13.

| | |
|---|---|
| Equation 20 | ${\sum }_{j ∈ {M}^{NA}} {PC}_{j} {u}_{j}$ |

An equation representing cost of non-analytical instruments, in which PCⱼ
and uⱼ have the same meaning as in table 2, and M^{NA} is the set of potential
non-analytical instruments.

The problem of selecting analytical instruments (and the configuration of what reagents should be allocated to which of those instruments) could then be addressed using equations such as set forth in table 1 to separately optimize the necessary instruments for each discipline having tests which the laboratory would process.

Other types of variations may also be possible. For example, in some embodiments which populate sets of potential instruments for optimization as described above, it may be possible to specify existing instruments which should be included in the sets and always be selected as constraints. This may be beneficial, for example, if a laboratory is considering expansion of its capabilities, and wants to know what additional instruments it should buy to do so, rather than what instruments would be optimal if it were operating on a completely blank slate. Similarly, if a laboratory is seeking to make long term strategic decisions regarding purchasing various types of instruments, it may utilize technology such as disclosed herein along with projections of demand for various types of test for the coming year. As another example of a type of variation which may be possible in some embodiments, some embodiments may be used to optimize selection and/or configuration of instruments which include analyzers associated with multiple disciplines. The may be done, for example, by modeling individual analyzers as having multiple parts, with each of the parts being associated with a particular discipline and having a capacity for holding reagents that would be used to perform tests in that discipline. A set of equations which, in some embodiments, may be used for identifying optimal instrument selections and configurations for these type of multi-discipline instruments is presented in table 3, below.

TABLE 3
Minimize

| | |
|---|---|
| | ${\sum }_{j ∈ M} \frac{1}{ND * {LS}_{j}} {PC}_{j} {u}_{j} + {\sum }_{h ∈ H} {\sum }_{s ∈ Q} {\sum }_{j ∈ {M}^{A}} {\sum }_{p ∈ P} {RC}_{hsj} {x}_{hsjp} + {\sum }_{h ∈ H} {\sum }_{j ∈ {M}^{A}} {\sum }_{p ∈ P} {ϱ}_{hj} {y}_{hjp}$ |
| Subject | APOCⱼₚ ≤ τⱼgⱼₚuⱼ; ∀ j ∈ M^{A}, p ∈ P |
| to | |
| | ${APOC}_{jp} \leq {\sum }_{h ∈ H} {\sum }_{s ∈ Q} {δ}_{hsj} {x}_{hsjp} ; ∀ j ∈ {M}^{A} , p ∈ P$ |
| | ${\sum }_{j ∈ {M}^{A}} {\sum }_{p ∈ P} {MDP}_{jpd} {APOC}_{jp} \geq {\sum }_{h ∈ H} {HD}_{hd} {F}_{h} ; ∀ d$ |
| | ${\sum }_{j ∈ {M}^{A}} {\sum }_{p ∈ P} {\sum }_{s ∈ S} {δ}_{hsj} {x}_{hsjp} \geq {F}_{h} ; ∀ h ∈ H$ |
| | ${\sum }_{h ∈ H} {\sum }_{s ∈ Q} {λ}_{hs} {x}_{hsjp} \leq {RK}_{jp} {u}_{j} ; ∀ j ∈ {M}^{A} , p ∈ P$ |
| | ${\sum }_{s ∈ Q} {λ}_{hs} {x}_{hsjp} \leq {RK}_{jp} {y}_{hjp} ; ∀ j ∈ {M}^{A} , h ∈ H , p ∈ P$ |
| | yₕⱼₚ ≤ HMPₕⱼₚ; ∀ j ∈ M^{A}, h ∈ H, p ∈ P |
| | ${\sum }_{j ∈ {M}^{NA - C}} {τ}_{j} {ϕ}_{j} {u}_{j} \geq {\sum }_{d = 1}^{p} {DC}_{d} {θ}_{d} + ω$ |
| | ${\sum }_{j ∈ {M}^{NA - AT}} {τ}_{j} {ϕ}_{j} {u}_{j} \geq η \cdot {\sum }_{d = 1}^{p} {θ}_{d} +$ |
| | ${\sum }_{j = 1}^{m} {ψ}_{j} {u}_{j} \leq β$ |

In table 3, the p is used as the index of an analyzer part in set P of analyzer parts, and other parameters which include references to part p should be understood as being analogous to similar parameters discussed previously in the context of single part analyzers. For example, APOCⱼₚ should be seen as analogous to APOCⱼ, and is used in table 3 to represent the operational capacity of part p of analyzer j. Similarly, xₕₛⱼₚ should be understood as the number of reagent bottles h with size s assigned to part p of analyzer j; MPD_{jpd} should be understood as a value representing if part p of analyzer j is in discipline d (and would be 1 if yes and 0 otherwise); HMPₕⱼₚ should be understood as a value representing if test h can potentially be done by part p of analyzer j (and would be 1 of yes and 0 otherwise); gⱼₚ should be understood as the hourly capacity of part p of analyzer j in terms of tests; RKⱼₚ should be understood as the number of reagent bottle positions of part p of analyzer j; and yₕⱼₚ should be understood as representing whether test h is done by part p of analyzer j (and would be 1 if yes and 0 otherwise). ND and LSⱼ have the same meaning as when those parameters were used in table 2.

As yet another example of a potential variation, it is possible that, in some embodiments, constraints and a cost function could be modeled in a way which omits calibration costs (discussed previously in connection with the parameter [symbol] ₕⱼ). For instance, this may be beneficial in cases where calibration costs are linked to specific tests run on instruments (e.g., those in the hematology discipline). Exemplary equations which could be used for identifying optimized instrument selections and reagent allocations while disregarding calibration costs which may be used in some embodiments are set forth below in table 4. In that table uⱼ would be an integer having a value of 0 or 1 depending on whether a particular instrument was selected, and all other parameters would have the same meanings as discussed previously in the context of equations 2-5 and 12-14 and table 2.

TABLE 4
Minimize

| | |
|---|---|
| | ${\sum }_{j ∈ M} \frac{1}{ND * {LS}_{j}} {PC}_{j} {u}_{j} + {\sum }_{h ∈ H} {\sum }_{s ∈ Q} {\sum }_{j ∈ {M}^{A}} {RC}_{hsj} {x}_{hsj}$ |
| Subject | AOCⱼ ≤ τⱼgⱼuⱼ; ∀ j ∈ M^{A} |
| to | |
| | ${AOC}_{j} \leq {\sum }_{h ∈ H} {\sum }_{s ∈ Q} {δ}_{hsj} {x}_{hsj} ; ∀ j ∈ {M}^{A}$ |
| | ${\sum }_{j ∈ {M}^{A}} {MD}_{jd} {AOC}_{j} \geq {\sum }_{h ∈ H} {HD}_{hd} {F}_{h} ; ∀ d ∈ D$ |
| | ${\sum }_{j ∈ {M}^{A}} {\sum }_{s ∈ Q} {δ}_{hsj} {x}_{hsj} \geq {F}_{h} ; ∀ h ∈ H$ |
| | ${\sum }_{h ∈ H} {\sum }_{s ∈ Q} {λ}_{hs} {x}_{hsj} \leq {RK}_{j} {u}_{j} ; ∀ j ∈ {M}^{A}$ |
| | ${\sum }_{s ∈ Q} {λ}_{hs} {x}_{hsj} \leq {RK}_{j} {HM}_{hj} ; ∀ j ∈ {M}^{A} , h ∈ H$ |
| | ${\sum }_{j ∈ {M}^{NA - C}} {τ}_{j} {ϕ}_{j} {u}_{j} \geq {\sum }_{d ∈ D} {DC}_{d} {θ}_{d} + ω$ |
| | ${\sum }_{j ∈ {M}^{NA - AT}} {τ}_{j} {ϕ}_{j} {u}_{j} \geq η \cdot {\sum }_{d ∈ D} {θ}_{d} +$ |
| | ${\sum }_{j ∈ M} {ψ}_{j} {u}_{j} \leq β$ |

Further variations on, features for, and potential implementations and applications of the inventors' technology will be apparent to, and could be practiced without undue experimentation by, those of ordinary skill in the art in light of this disclosure. Accordingly, neither this document, nor any document which claims the benefit of this document's disclosure, should be treated as being limited to the specific embodiments of the inventor's technology which are described herein.

As used herein, the singular forms “a”, “an”, and “the” include plural referents unless the context clearly dictates otherwise. The invention has now been described in detail for the purposes of clarity and understanding. However, it will be appreciated that certain changes and modifications may be practiced within the scope of the appended claims.

As used herein “laboratory instrument” or “instrument” refers to a device which is used in analyzing samples or facilitating or enabling that analysis. Examples of these types of devices include analytic instruments, centrifugation machines, and sorting and routing machines.

As used herein, the term “machine” refers to a device or combination of devices.

As used herein, the term “set” refers to a number, group, or combination of zero or more things of similar nature, design, or function.

As used herein, a statement that a thing is done “without any manual intervention” means that the thing is done automatically.

As used herein, the term “based on” means that something is determined at least in part by the thing that it is indicated as being “based on.” To indicate that something must be completely determined based on something else, it would be described as being based “exclusively” on whatever it is completely determined by.

As used herein, modifiers such as “first,” “second,” and so forth are simply labels used to improve readability, and are not intended to imply any temporal or substantive difference between the items they modify. For example, referring to items as a “first program” and a “second program” in the claims should not be understood to indicate that the “first program” is created first, or that the two programs would necessarily cause different things to happen when executed by a computer. Similarly, when used in the claims, the words “computer” and “server” should be understood as being synonyms, with the different terms used to enhance the readability of the claims and not to imply any physical or functional difference between items referred to using those different terms.

1. A method implemented on a device comprising at least a processor, the method comprising:
a) defining a formal representation of demand for tests to be performed at a laboratory; and
b) providing a recommendation of one or more laboratory instruments for performing the tests and an allocation of reagents among the one or more laboratory instruments based on the formal representation comprising a set of pre-defined parameters to optimize a cost associated with performing the test.

2. The method of claim 1, wherein the recommendation comprises a recommended allocation of reagents between the one or more laboratory instruments.

3. The method of claim 2, wherein the recommendation comprises a recommendation to purchase one or more laboratory instruments not already present at the laboratory.

4. The method of claim 3, wherein the recommendation comprises a recommendation to use at least one laboratory instrument which is already present at the laboratory.

5. The method of claim 4, wherein the one or more laboratory instruments comprises at least one laboratory instruments capable of performing tests in multiple disciplines.

6. The method of claim 5, wherein the multiple disciplines comprise at least two disciplines selected from a group consisting of:
a) immunology;
b) chemistry;
c) hematology; and
d) coagulation.

7. The method of claim 6, wherein the recommendation is based on minimizing a cost function representing one or more costs for performing one or more pre-analytic operations.

8. The method of claim 7 wherein the one or more pre-analytic operations comprise sorting and centrifugation.

9. A computer program product comprising a non-transitory computer readable medium storing instructions operable to configure a computer to provide a recommendation of one or more laboratory instruments for performing the tests and an allocation of reagents among the one or more laboratory instruments based on a formal representation of demand for tests to be performed at a laboratory, wherein the formal representation of demand for tests to be performed at the laboratory comprises a set of pre-defined parameters to optimize a cost associated with performing the test.

10. (canceled)

11. The computer program product of claim 9, wherein the recommendation comprises a recommended allocation of reagents between the one or more laboratory instruments.

12. The computer program product of claim 11, wherein the recommendation comprises a recommendation to purchase one or more laboratory instruments not already present at the laboratory.

13. The computer program product of claim 12, wherein the recommendation comprises a recommendation to use at least one laboratory instrument which is already present at the laboratory.

14. The computer program product of claim 13, wherein the one or more laboratory instruments comprises at least one laboratory instruments capable of performing tests in multiple disciplines.

15. The computer program product of claim 14, wherein the multiple disciplines comprise at least two disciplines selected from a group consisting of:
a) immunology;
b) chemistry;
c) hematology; and
d) coagulation.

16. The computer program product of claim 15, wherein the recommendation is based on minimizing a cost function representing one or more costs for performing one or more pre-analytic operations.

17. The computer program product of claim 16 wherein the one or more pre-analytic operations comprise sorting and centrifugation.

18. A machine comprising a computer configure with a set of instructions operable to, when executed, provide a recommendation of one or more laboratory instruments for performing the tests and an allocation of reagents among the one or more laboratory instruments based on a formal representation of demand for tests to be performed at a laboratory, wherein the formal representation of demand for tests to be performed at the laboratory comprises a set of pre-defined parameters to optimize a cost associated with performing the test.

19. The machine of claim 18, wherein the recommendation comprises a recommended allocation of reagents between the one or more laboratory instruments.

20. The machine of claim 19, wherein the recommendation comprises a recommendation to purchase one or more laboratory instruments not already present at the laboratory.

21. The machine of claim 20, wherein the recommendation comprises a recommendation to use at least one laboratory instrument which is already present at the laboratory.
